(19) United States
(12) Patent Application Publication
(10) Pub. No.: US 2009/0207103 A1
(43) Pub. Date: Aug. 20, 2009

(54) Light-emitting hologram based on Organic Polymeric Diode - (OLED/PLED)

(76) Inventor: Igor Gregory Mative, (US)

Correspondence Address: Igor Gregory Mative, Silver 12/7, Nahariya, 22385, omitted

(21) Appl. No.: 12/031,920

(22) Filed: Feb. 15, 2008

(51) Int. Cl. G09G 3/30

(52) U.S. Cl. 345/76

(57) ABSTRACT

The present invention concerns a color display device. The pixel of display consists of three light-emitting two-dimensional holograms, of blue, green and red colors. The holograms are formed as interference pictures, and registered on an organic layer of the polymeric diode. The polymer layer radiates a full spectrum of white light, but at the expense of holographic cracks, take place, some optical effects, which influence on wavelength of light, as well, color of pixel.

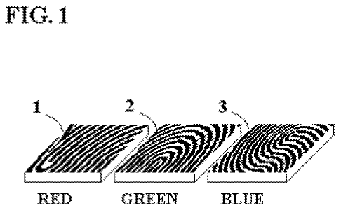

The main feature of the given invention in uses of light-emitting holograms for creation a pixel of display. On FIG. 1 are shown, three sites of organic polymers, which are forming the pixel. On each site 1, 2 and 3, is shown in an enlarged view, interference picture, which has been written down on a layer of organic polymer, in other words, holograms. Each of holograms radiates one of three colors, 1 red, 2 green and 3 blue. Changing intensity of light of holograms, at the expense of change of voltage on structure HCOLED (Holographic Color Organic Light-Emitting Device), it's possible to change color of pixel. The size of pixel consisting of three holograms can be from around 10 micron and more. If to take average value of pixel 0.1 mm, hence size of each hologram can be approximately 0.03×0.03 mm.

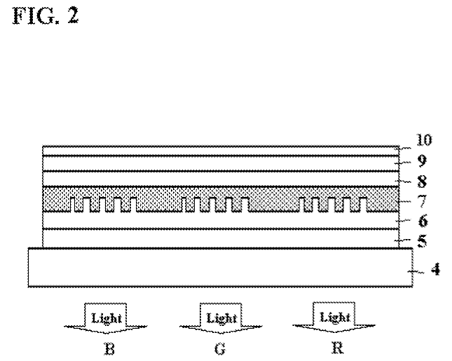

On FIG. 2 is shown, architecture of HCOLED display pixel. The substrate 4 can be made of any transparent material, such as glass, plastic and so on. Layer over the substrate, is an electrode the anode—5. Given layer can be made from ITO. Over the anode, there is a transport level for holes HTL—6. The layer number 7 represents the main interest in all scheme of HCOLED. On this level are located holograms. All structure of pixel is shown in profile (section), therefore are well visible a cracks of hologram, its interference picture of holograms, created on an organic layer of polymer. In the given concrete case, the layer should radiate full spectrum of white light, or blue light. The layer can be executed from one kind of organic polymer, or can be the composite layer, which consist, from several kinds of polymers. The following layer 8 can function as transport level for electrons ETL. Over the ETL, is located the cathode 9. The last layer of HCOLED structure is a protective layer. It can be used, as well as a reflective mirror or in any other cases. It's significant, that HCOLED architecture can have another structure, with more layers or vice versa, on much less, than on FIG. 2. The main thing here is a light-emitting organic polymer layer, which consists of two-dimensional holograms, which is a major core of all HCOLED structure.

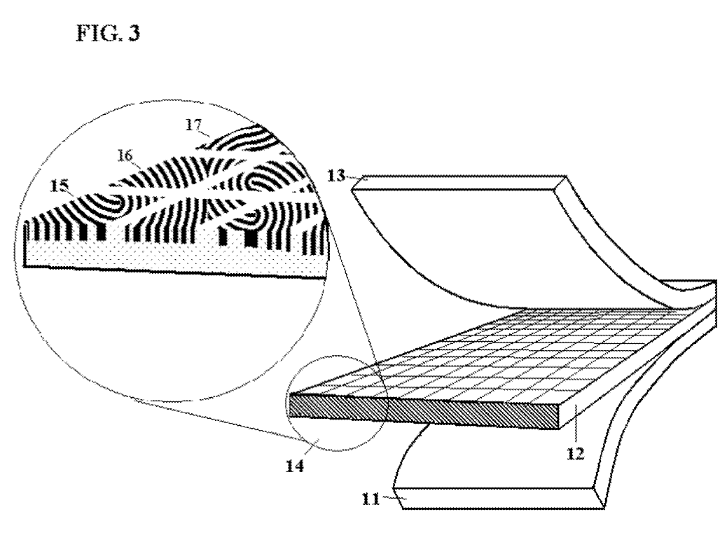

FIG. 3 shows HCOLED structure, in three-dimensional image. The accent of drawing is made on a polymeric layer 12 on which is present the system of holographic pixels. Drawing reminds a pie, which consists of three layers where between its two parts, 11 (ETL, the cathode and a protective layer) and 13 (a substrate, the anode and HTL), disposes a “cream” of pie, 12 an organic polymer layer. The layer 12 is divided into sites, in form of rectangles. Each rectangular site is the hologram, radiate light with certain wavelength. I(not 14, pursues the aim, to show in three-dimensional image, holograms united in pixel, the depth of their cracks and distances between them. The pixel consists from three holograms 15, 16 and 17, which represents one of three colors. The pixel concerning the screen is located horizontally. Hence, after the blue hologram 17, starts a new pixel where its first hologram as well as 15 is red one, and behind it green and so on. Streaks of black color, are represents a cracks of holograms, just to show their depths.

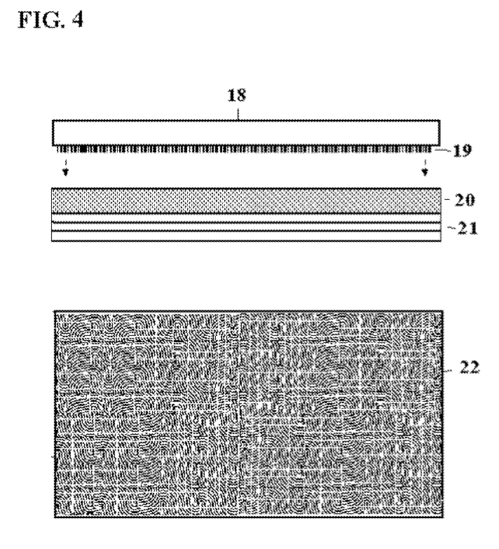

On FIG. 4 explains about one of possible methods of creation of holographic pixels, for display device based on HCOLED. The technology of stamp of holograms exists a long time and is used for printing of two-dimensional holographic images. Holographic pixels have, as well, two-dimensional interference structure, therefore this principle of “stamp”, it's possible to use for HCOLED technology. The first of all should be created a cliche (stamp), which will be used as a stamp. The stamp, as a rule, is making from aluminum 18. On the bottom side of 18, produces two-dimensional interference picture (it is shown in the form of a bristle 19) depending on type of pixels and a screen diagonal. The module of creation of holographic pixels is on the middle of all process technology HCOLED. What to start to print, it's necessary to prepare at the first working layers 21 and, the organic polymeric layer 20. Next the stamp 18 under certain pressure deforms a layer 20, so after printing, will be possible to see a “relief” 22 (after enlarge), in the form of cracks, this is a multi-system of holographic pixels.

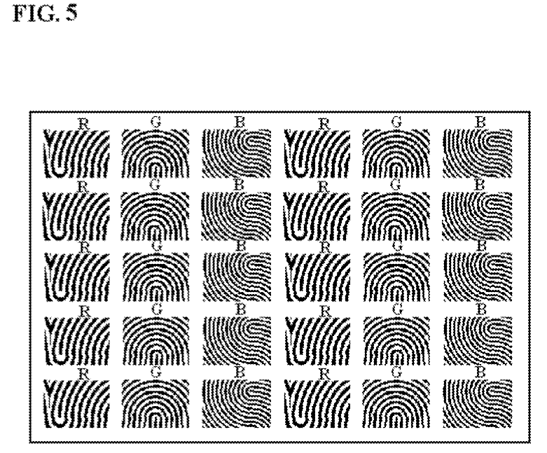

On FIG. 5 are shown, 10 pixels, two on across (horizon) and five vertically, an enlarged view. As shown on picture, each pixel has identical holograms. It's made in order; each color of pixel would have identical value. The amplitude of a wave associates with the energy, in this case the energy of each color will be identical, that will allow avoiding problems connected with contrast of colors.

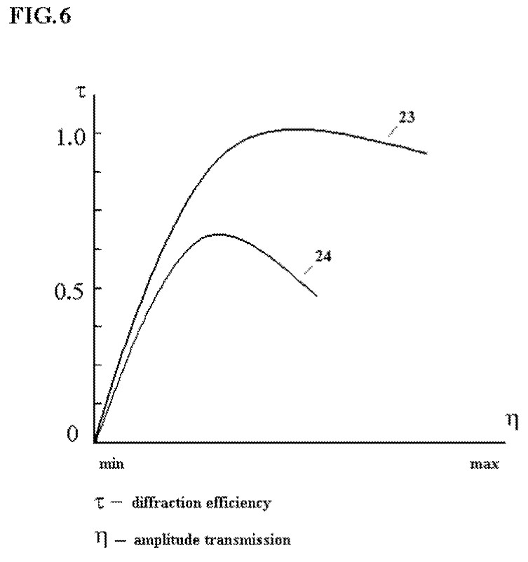

Following FIG. 6 draws an analogy, between light-emitting holograms and transmitted diffraction grid. Why it's made, and why it's so important? There are technologies which use transmitted diffraction grid as light's filters, for modulation of color of pixel. In classical optics the concept “transmitting” is used in terms of sense energy, and defined as the relation of intensity of transmitted light to intensity of the incident light. In this case amplitude transmission −η, defines intensity of light of pixel, as well makes influences to the speed of change of intensity, defined as −τ (diffraction efficiency). Speed of change of intensity pixel's color, in display technology plays very important role. The line at number 23 shows changes along amplitude and along diffraction efficiency, of light-emitting hologram (main principle of the given idea), number 24 it's a transmitted diffraction grid. Apparently, factor −η at light-emitting hologram, almost twice higher, than at diffraction grid. The same tendency is observed and on −τ. What conclusion can we draw? To use a light-emitting hologram as a display's pixel, more effectively than, if to use for the same purposes, a filter as transmitted diffraction grid.

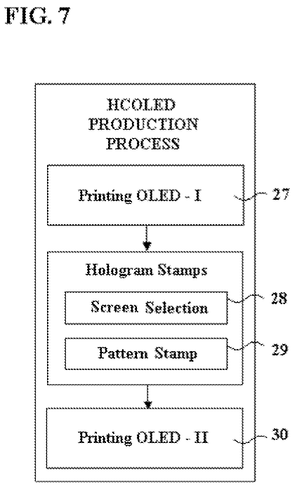

FIG. 7 shows scheme of technological process of manufacture HCOLED. There are three main modules, first is “preparatory”, second “main” and last one “finishing”. The preparatory module 27 creates working layers. Such as electrode, transport layer, and light-emitting organic polymer layer. Further management passes to the second main module of all process (28 and 29). Here occurs a stamp of holographic pixels. The first of all creates a form of stamp, which depends on the type of screen 28. Usually its makes from aluminum. When the form of stamp is ready, begins process of printing. Manufacturing of stamps can be executed separately from all process. After the aluminum matrix (form) is ready, produces stamping 29, of holographic pixels, on an organic polymer layer. Given process of stamping, can occupy no more than one second. Further appears on a scene, module—“finishing” 30. After the system of holographic pixels is ready, it's necessary to finish HCOLED structure. Should be are imposed layers, such as an electrode, transport and protective layer.

1. Pixel of OLED display consists from three light-emitting two-dimensional holograms, blue, green and red colors. All of three holograms are created on light-emitting layer of organic polymeric diode radiating white or blue light.

2. Pixel of OLED display consists from three transmitted holograms, transmitting blue, green and red colors. All three holograms are created on a layer of organic polymer, which is not used as light-emitting layer, only as a filter for white or blue light. The given polymeric layer, is not relates to OLED architecture, only as thin film filter, located over the substrates of OLED.

3. The display device uses architecture of pixel of claim 1, technology defined as—Holographic Color Organic Light-Emitting Diode (HCOLED).

4. The display device uses architecture of pixel of claim 2, technology defined as—Holographic Color Organic Light-Emitting Diode (HCOLED).

5. The television display device, of claims 3 or 4.

6. The computer display device for laptops and pocket computers, of claims 3 or 4.

7. The display device for wireless phone, of claims 3 or 4.

8. Displays to household and office equipments, based on HCOLED, of claims 3 or 4.
